(19) United States
(12) Patent Application Publication
(10) Pub. No.: US 2025/0226125 A1
(43) Pub. Date: Jul. 10, 2025

(54) SYSTEMS AND METHODS FOR AUTOMATED PLANT CONTROL

(71) Applicant: GE-HITACHI NUCLEAR ENERGY AMERICAS LLC, Wilmington, NC (US)

(72) Inventors: Jerry W. Nicholson, Leland, NC (US); Marc M. Culig, Hampstead, NC (US); Ira D. Poppel, Wilmington, NC (US)

(21) Appl. No.: 18/405,368

(22) Filed: Jan. 5, 2024

(51) Int. Cl. G21D 3/00; G21C 7/12; G21C 7/32; G21D 3/10

(52) U.S. Cl. CPC G21D 3/001; G21C 7/12; G21C 7/32; G21D 3/008; G21D 3/10

(57) ABSTRACT

Systems and methods provide data gathering and execution on the same without human operations. Systems may include controls and sensors that electronically provide data and operations to a processor networked with the same. For a nuclear reactor, the processor may determine reactivity from the sensors and issue commands to actuators to operate the reactor. Reactivity may be determined based on all reactivity factors determined from the plant data, including the use of modelling. The processor may position control elements or moderator feeds to achieve a desired reactivity. The processor may be networked to plant switches and sensors, and multiple processors may be used to independently calculate and decide on plant operations. Human operator input is not required at discreet instances of plant operational change; systems may include displays and input interfaces to permit observation and/or intervention if absolutely necessary.

### BACKGROUND

FIG. 1 is a schematic of related art instrumentation and control (I&C) system 100 used to operate a plant generating power or other industrial products with operator input. I&C system 100 may include remote input/output signal processing equipment 110 that interfaces with plant sensors and actuators, shown by external sources and targets within arrows reflecting inputs and/or outputs. For example, in a nuclear power plant I/O equipment may interface with equipment used to control the positioning of reactor control elements and coolant pumps or circulators. U.S. Pat. Nos. 11,276,504 and 10,910,115 to Nicholson et al. disclose similar I&C systems for nuclear reactor control elements and are incorporated herein by reference in their entirety. I&C system 100 may include controllers and local I/O modules 120 that execute system application software logic to execute plant control and monitoring functions and process local input/output signals for equipment near the controllers, including system human machine interface (HMI) 130. I&C system 100 may include system HMI 130 that provides indications to and receives inputs from operators.

Controllers and local I/O modules 120 include controllers 123 in a triple modular redundant (TMR)—three controller—or quad modular redundant (QMR)—four controller—configuration to execute application software logic for all modes and states of plant operation, including startup, power operation, shutdown, and off-normal operations. Each system controller 123 may execute the same application software logic independently and asynchronously. Two-out-of-three voting for TMR configurations, or two-out-of-four voting for QMR configurations, may determine the state of system input and output signals. Multiple controllers 123 ensure continued capability to perform applicable voting of inputs, with continued execution of the control software logic without operator intervention in the event of a loss of a redundant input or instrument channel.

I&C system 100 may be controlled by application software having a series of modules each having of a series of functions, methods, or programmable logic threads that determine the state of outputs and control variables based on the state of inputs. Programmable sequence function charts (SFCs), software task enabling/disabling, or conditional logic is used to control portions of the software logic, and to control data flow through it. The SFCs and software logic are structured to establish and ensure that control functions are executed in a predetermined sequence, similar to that performed by the reactor operator(s) for a manually controlled reactor. Within the SFCs, conditional logic enables or disables threads of software logic and controls the flow of software logic from one module of the software to another.

Local I/O modules 125 are used to process input and output signals from local equipment that may interface with controllers 123 via switches 122 across network 121, which may be an ethernet or other digitized network configured for communication with controllers 123. The local equipment may include sensors and actuators, hardwired switches 131, alarms 132, and indicators 133 included in the system HMI 130. Local I/O modules 125 are configured in a TMR or QMR configuration with either three or four I/O controllers configured to process the type of I/O signals handled by the module. Examples of types of I/O signals include discrete, analog, thermocouple, vibration, serial, and digital communications using industry-standard communication protocols.

Redundant input signals are provided to I&C System 100 for those signals used in control of the reactor. Each of the redundant input signals is processed by unique I/O module 125 to ensure that adequate inputs exist for voting of input signals in the event of failure of a single I/O module 125. The state of outputs on an I/O module is determined based on two-out-of-three or two-out-of-four voting of the output state determined by each I/O controller on the I/O module 125. For discrete outputs that are used for control of the reactor, the output from each I/O module 125 is configured in a series/parallel configuration with the outputs of other I/O modules providing control outputs for the same control parameter. This ensures that final control outputs from the system are based on two-out-of-three voting even in the presence of a single component failure (e.g., output relay failure). For analog outputs used for control of the reactor, the final system output is determined based on a median select of the redundant control outputs for the same control parameter. Communications with I/O modules using industry standard communication protocols are performed using a network ring topology which ensures reliability of the communications in the presence of a single failure of a component or data link within the communications ring.

Redundant I/O network switches 122 are used to relay multiplexed communication data from local and I/O module I/O controllers 125 to I&C system controllers 123. I/O network switches 122 support communications with I/O module controllers 125 over copper or fiber optic media, as needed for a given system application. For example, where the distance between remote I/O modules 115 and I&C system controllers 120 is great or electromagnetic interference is present, fiber optic cable is used.

I&C System Human Machine Interface 130 receives simple limited inputs from and provides high level reactor status indications to operators for confirmation of proper operation of the automated control system. From HMI 130, plant operators request plant startup, shutdown, power setpoint(s) at which the reactor will be controlled by the automated control system etc. via HMI server 135 interfacing with human input devices 134 such as keyboards or touchscreens. The control input requests are transmitted from HMI 130 to control network 127 for input to controllers 123 via switches 126. Application software logic in I&C system controller 123 evaluates operator control input requests from HMI 130 and implements them only if all prerequisites, permissions, and interlocks are met for their implementation. Hardwired controls 131 are provided to support manual shutdown of the reactor in the event of failure of I&C system 100. Hardwired shutdown controls 131 are designed to function irrespective of the state of I&C system controllers 123, I/O modules 125, and other components executing software. The I&C system control logic is designed to continue plant operation in a predetermined state based on setpoints stored on and software logic executed by the system controllers. Power distribution components 124 may receive local or plant power to power all off the input, output and processing devices in HMI 130 and local I/O modules 120.

Remote I/O modules and equipment 110 are provided where needed to interface with reactor sensors and actuators. The functioning of remote I/O modules 115 and switches 116 is the same as that of local I/O modules 125 and switches 122 described above, and may receive input from the same to reflect the same switch settings, input, and output. Switches 116 may communicate across network 117, which may be an ethernet or other digitized network. Variable speed/frequency power sources 111 are included with the remote I/O modules 115 to control movement of control elements to a commanded position at a commanded speed. Variable speed/frequency power source 111 is also provided to control the speed of the coolant pump or circulator and therefore mass flow of coolant through the reactor. Analog-to-digital converters 112 may receive and translate control element position information. Power distribution components 114 may receive local or plant power to power all off the input, output and processing devices in remote I/O modules 110. Ethernet network 113 may permit communication between remote I/O modules and equipment 110 and local I/O modules and equipment 120.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems of monitoring and commanding industrial systems like nuclear power plants without need for human operator intervention to achieve a change in system status in the short or long term. Example embodiment systems may include controllers that can change the facility physical configuration, like pump and turbine actuators and speed controls, control rod drives, fuel feeds, etc. Example embodiment system may include sensors that can detect the facility physical configuration, including coolant and fuel temperatures, moderator flow rates, energy production rates, control element positions, etc. and report the same electronically. Example systems include a computer or other configured processor interfaced with the controllers and/or sensors and programmed to handle multiple pieces of data from/to the same for operations. For example, the processor may determine reactivity of a nuclear reactor from the sensors and/or issue operational commands to plant actuators to maintain operations or achieve a different reactivity. The controller could use a simple reactivity summation across provided contributing factors and/or a physics model simulating the plant to determine reactivity, for example, and issue commands of control rod positioning and/or moderator flow volumes in response. For a nuclear power plant instrumentation and control module, the processor may be connected between remote or local I&C I/O switches and sensors. Multiple independent processors may be used, for example one per switch, and example embodiment system may resolve operation commands issued by the processors through a majority-or at-least-half-rule of the controllers distinctly interfaced with the switches. While human operator input is not required in a continuous, day-to-day, or even month-to-month manner, example embodiment systems may include displays and input interfaces for operators to monitor facility operations and potentially input overriding commands or high-level operating goals such as target reactivities, power levels, cycle lengths, etc.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is a schematic of a related art plant instrumentation and control system.

FIG. 2 is schematic of an example embodiment plant instrumentation and control system.

FIG. 3 is a flow chart of an example configuration for an example embodiment system.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,”

“on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that typical industrial plant operations require operator intervention on a continuous or at least daily basis to achieve desired operations. Without continuous human feedback, no facility-wide analysis or configuration changes are implemented, and the facilities may enter unproductive or dangerous conditions. Moreover, where individual components may have failsafe or shutdown routines for their independent operation, there is no facility-wide automated controller that can coordinate and keep operable all such components. This is more so true for nuclear power plants, where there may be no single plant processor or instrumentation to gather plant-wide data and/or provide automated operations to all components. To overcome these newly-recognized problems as well as others, the inventors have developed example embodiments and methods described below to address these and other problems recognized by the inventors with unique solutions enabled by example embodiments.

The present invention is instrumentation and control systems for industrial facilities and methods of operating such facilities. In contrast to the present invention, the few example embodiments and example methods discussed below illustrate just a subset of the variety of different configurations that can be used as and/or in connection with the present invention.

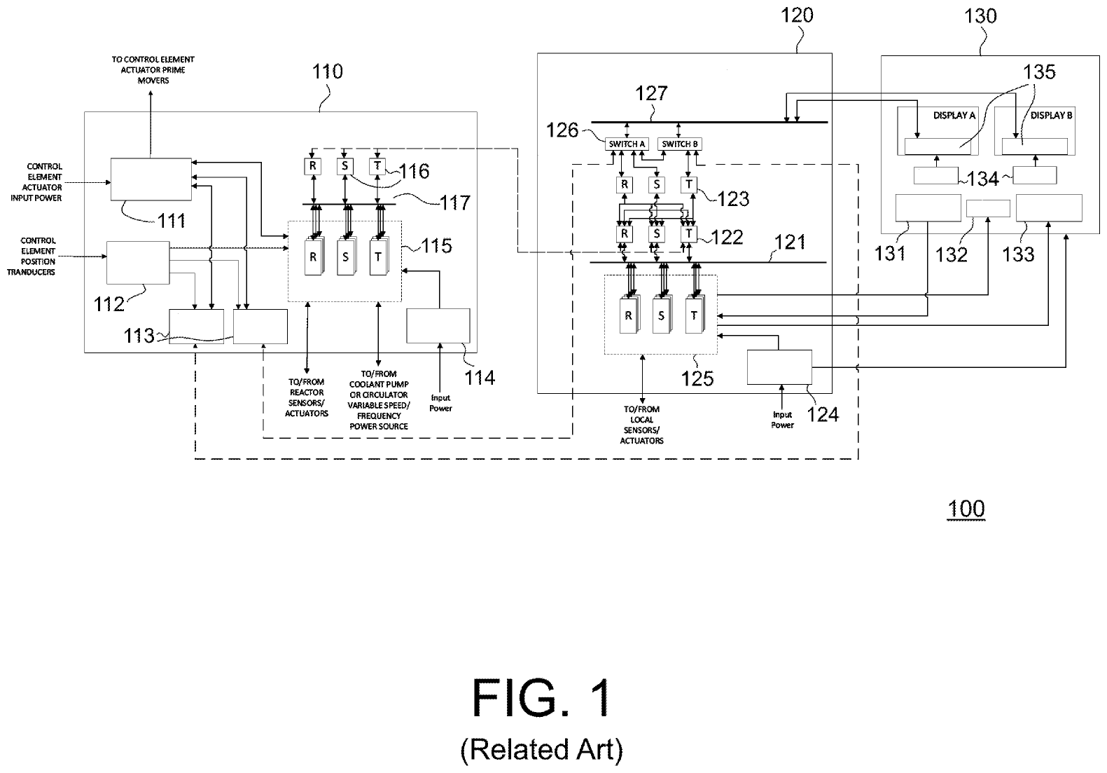

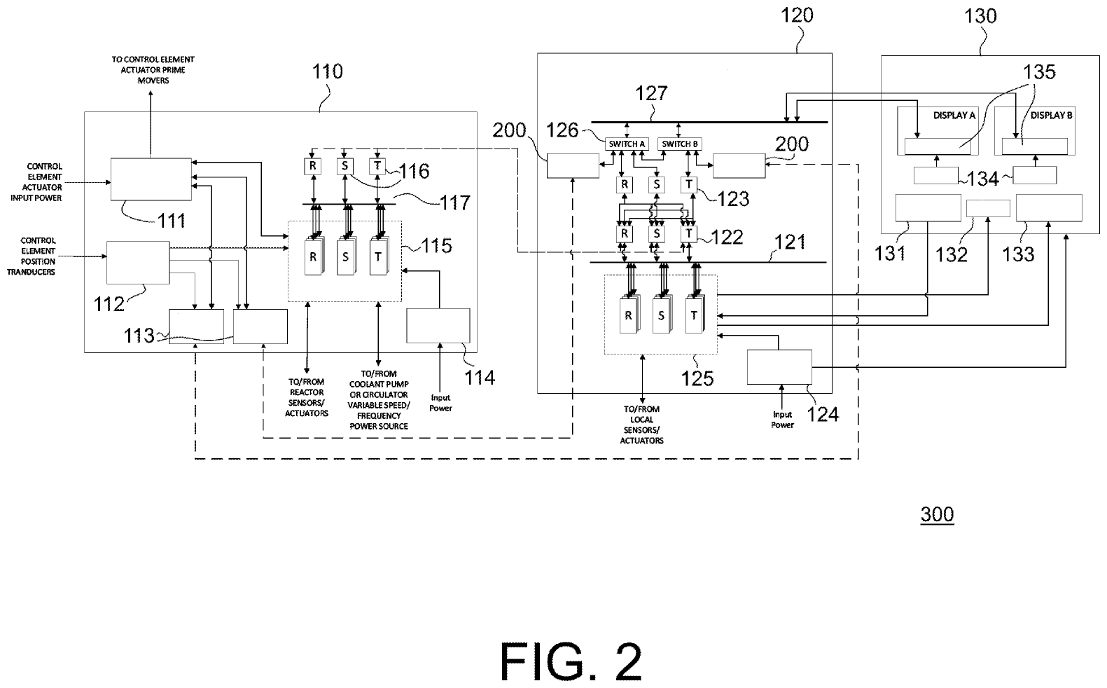

FIG. 2 is a schematic of an example embodiment automated instrumentation and control (I&C) system 300 that can operate a nuclear power plant. Example embodiment automated I&C system 300 may include similar components and interfaces as I&C system 100 of FIG. 1, which may serve as a baseline with similar numbering among similar components. Example embodiment automated I&C system 300 includes one or more multivariable controllers 200 interfaced with controllers and local I/O modules 120 to execute plant control and monitoring functions with minimal or no human operator input for lengthy periods of time. For example, multivariable controllers 200 may interface with and control switches 126 to provide input to controllers 123. Similarly, multivariable controllers 200 may interface with remote I/O modules and equipment 110 to have all plant inputs and sensor data via ethernet network 113. One multivariable controller 200 per channel and switch is shown in the schematic of FIG. 2, but a single or any number of controllers 200 can be used in system 300. Each multivariable controller 200 may be independent, determining inputs and outputs without action or involvement of other, to provide redundancy.

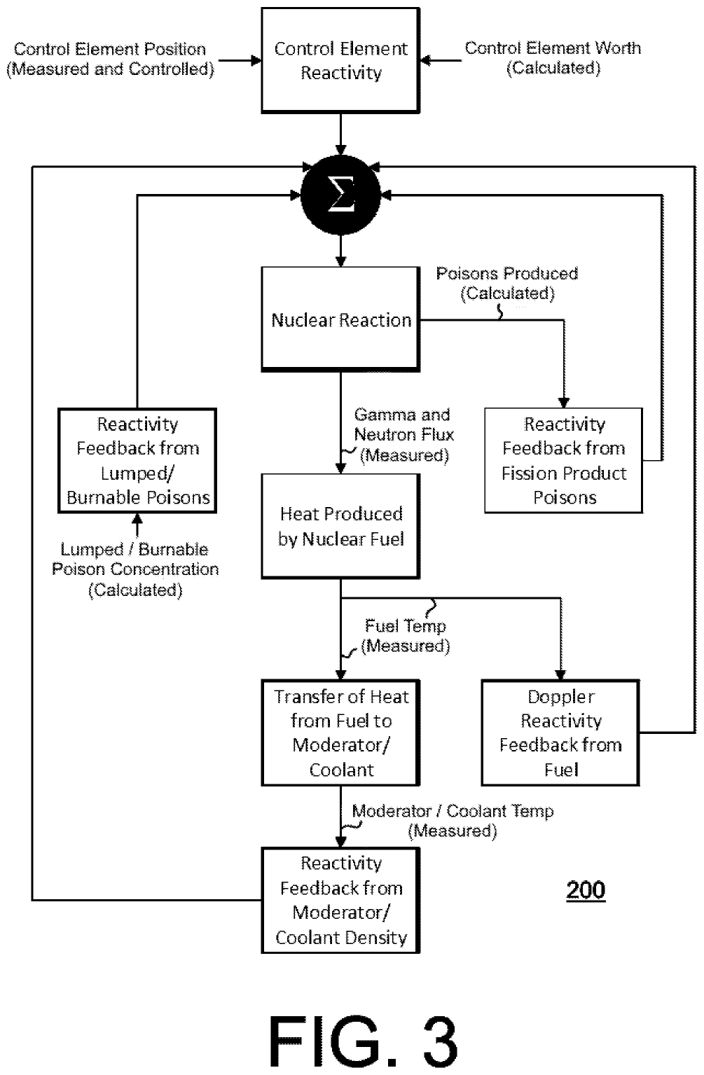

FIG. 3 is an illustration of an example embodiment configuration of multivariable controller 200 for calculating reactor reactivity, which in turn may be used to control plant operations. For example, controller 200 may perform reactor reactivity calculations to determine reactor core reactivity (shown as Sigma) from control element, burnable and fission poisons, doppler, and moderator density worths. The reactivity calculated from these inputs may also determine what control element step, or any change in change in control element position, causes a specified reactivity and power change and resulting changes in reactor/coolant temperature or core thermal power. Similarly, control element insertion and withdrawal sequence for multiple control elements, estimated control element critical position for startup, and core thermal power to coolant flow ratio may be calculated based on reactivity response. Reactivity responses can be formulated for any plant configuration given these physical inputs, and methodology for configuration of multivariable controller 200 for similar calculations may follow DOE Fundamentals Handbook, Nuclear Physics and Reactor Theory, Vol 2, January 1993, for example, incorporated herein by reference in its entirety.

Multivariable controllers 200 may be further configured with physics models for a more detailed determination of reactor responses, including reactor heat transfer coefficients, temperature dependent reactivity coefficients, control element reactivities (worth), fuel depletion (burnup), and the quantity of fission product poisons present in the reactor core. Heat transfer of the coolant may be modeled to account for the need to limit reactor power in response to changes or faults in the coolant system. For example, models using TRACG, SCDAp/RELAP, MELCOR, etc. may be provided with plant configuration to allow multivariable controllers 200 to determine plant response from any change in control element position and/or coolant flow rate. Additionally, multivariable controllers 200 may be coupled with point or spatial kinetics formulations to predict neutronic behavior of the reactor based on operational power history of the reactor to determine this response.

Multivariable controllers 200 may determine an expected change in reactor power in thermal and neutron flux terms, and coolant temperature, resulting from changes to control element position and/or moderator/coolant flow rates. Similarly, multivariable controllers 200 may calculate the opposite, control element position(s) and/or moderator/coolant flows that will achieve a reactivity, power level, and/or coolant/moderator temperature. These calculations are used to establish limits for plant control by I&C controllers 123, and in conjunction with inputs from plant sensors, to confirm proper response of the reactor following control element repositioning, valve reconfigurations, moderator pump speed changes, etc. This feedback essentially provides closed loop control of reactor power and temperature to support automated control of the reactor.

As shown in FIG. 2, inputs to multivariable controllers 200 are provided from I&C controllers 123 and from ethernet network 113 providing all sensor input from remote I/O modules and equipment 110. In this way, for example, multivariable controllers 200 may process inputs from control element position transducers and converters 112 and provide output to the control element variable speed/frequency power sources 111 for control element movement. As shown in FIG. 2, controllers 200 may be input through distinct switches 126, to achieve control and even in the instance of failure of a single channel. Although multivariable controllers 200 are shown in local controllers and local I/O modules 120, they may be at any location, or co-located with all of remote controllers and local I/O modules 120 and local controllers and local I/O modules 110, where they can receive plant inputs and output desired commands.

Because multivariable controllers 200 may directly interface with plant controllers and receive sensor data from the same, controllers 200 may effectively replicate or replace human input through HMI 130, such that a plant can be operated without human constant monitoring or interface up to full automation. Reactor startup, operation at power, and reactor shutdown can all be automated with direct control interface of controllers 200, with human operators potentially only monitoring and/or inputting high-level goals. Further, this automation can be achieved despite failure of sensors, actuators, input/output modules and controllers in a shingle channel, with such failures being bypassed. This streamlined deterministic reactor control may minimize the potential for human error and assure high reliability and availability of nuclear reactor controls.

Some example embodiments and methods thus being described, it will be appreciated by one skilled in the art that examples may be varied through routine experimentation and without further inventive activity. For example, although commercial nuclear power plant control systems are used in some example methods, it is understood that other plants are useable with example embodiments and methods.

Variations are not to be regarded as departure from the spirit and scope of the example embodiments, and all such modifications as would be obvious to one skilled in the art are intended to be included within the scope of the following claims.

1. A system for instrumentation and control of a nuclear power plant, the system comprising:
a plurality of system controllers interfaced with plant actuators;
a plurality of plant sensors communicatively connected with the system controllers; and
a processor-based multivariable controller receiving sensor data from the plant sensors and providing commands to the plurality of system controllers, wherein the multivariable controller is configured to calculate plant reactivity from the sensor data and output commands to the plurality of system controllers to achieve a desired reactivity calculated from the plant reactivity and the sensor data.

2. The system of claim 1, further comprising:
a plurality of switches, wherein each switch is communicatively connected to a distinct set of the system controllers, and wherein the multivariable controller connects to the system controllers through at least one of the switches.

3. The system of claim 2, wherein there are at least three system controllers, and wherein a majority of the system controllers receive a same command or the command is not provided to the plant actuators by the controllers.

4. The system of claim 3, wherein there are a plurality of the multivariable controllers, wherein each of the multivariable controllers provides commands to a distinct switch of the plurality of switches.

5. The system of claim 2, further comprising:
a human-machine interface including a display and input device communicatively connected to the switches, wherein no input from the human-machine interface is required for the multivariable controller to output the commands.

6. The system of claim 1, wherein the sensor data includes control element position, fuel temperature, radiation flux, and moderator temperature.

7. The system of claim 6, wherein the multivariable controller is further configured to calculate control element worth and reactivity, burnable and fission product poison reactivity, fuel doppler reactivity, and moderator feedback reactivity from the sensor data.

8. The system of claim 7, wherein the multivariable controller is configured to calculate plant reactivity from the control element reactivity, burnable and fission product poison reactivity, fuel doppler reactivity, and moderator feedback reactivity.

9. The system of claim 8, wherein the multivariable controller is configured with a simulation model of the plant to calculate the reactivity and output commands to achieve the desired reactivity.

10. The system of claim 1, wherein the commands include at least one of control element position and moderator flow rate.

11. The system of claim 1, further comprising:
an ethernet network, wherein the multivariable controller is configured to receive the sensor data over the ethernet network.

12. A method of controlling a nuclear power plant with a processor-based multivariable controller, the method comprising:
receiving sensor data at the multivariable controller from a plurality of plant sensors communicatively connected with system controllers for the nuclear power plant;
calculating, with the multivariable controller, plant reactivity and commands that achieve a desired reactivity calculated from the plant reactivity and the sensor data; and
providing the commands from the multivariable controller to a plurality of system controllers interfaced with plant actuators, wherein the method does not include human operator input.

13. The method of claim 12, further comprising:
executing the commands by the plant actuators to place the plant in a physical condition that achieves the desired reactivity.

14. The method of claim 12, each switch of a plurality of switches is communicatively connected to a distinct set of the system controllers, and wherein the multivariable controller connects to the system controllers through at least one of the switches.

15. The method of claim 14, wherein there are at least three system controllers, and wherein a majority of the system controllers receive a same command or the command is not provided to the plant actuators by the controllers.

16. The method of claim 15, wherein there are a plurality of the multivariable controllers, wherein each of the multivariable controllers executed the receiving, calculating, and providing to a distinct switch of the plurality of switches.

17. The method of claim 12, wherein the sensor data includes control element position, fuel temperature, radiation flux, and moderator temperature.

18. The method of claim 17, wherein the calculating includes calculating a control element worth and reactivity, burnable and fission product poison reactivity, fuel doppler reactivity, and moderator feedback reactivity from the sensor data.

19. The method of claim 18, wherein the calculating includes calculating the plant reactivity from the control element reactivity, burnable and fission product poison reactivity, fuel doppler reactivity, and moderator feedback reactivity.

20. The method of claim 12, wherein the commands include at least one of control element position and moderator flow rate.
